(19) United States
(12) Patent Application Publication
(10) Pub. No.: US 2009/0278363 A1
(43) Pub. Date: Nov. 12, 2009

(54) Active Materials Based Impact Management Systems

(75) Inventors: Alan L. Browne, Grosse Pointe, MI (US); Nancy L. Johnson, Northville, MI (US)

Correspondence Address: Quinn Law Group, PLLC, 39555 Orchard Hill Place, Suite 520, Novi, MI, 48375, US

(73) Assignee: GM GLOBAL TECHNOLOGY OPERATIONS, INC., Detroit, MI (US)

(21) Appl. No.: 12/117,368

(22) Filed: May 8, 2008

(51) Int. Cl. B60R 19/38

(52) U.S. Cl. 293/118; 701/45

(57) ABSTRACT

A vehicle includes a vehicle body and a member being mounted with respect to the vehicle body. The member is selectively movable between first and second positions with respect to the vehicle body. An actuator includes an active material that is configured to undergo a change in at least one attribute in response to an activation signal. The active material is operatively connected to the member such that the change in at least one attribute causes the member to move relative to the vehicle body. An impact detection system is configured to detect at least one condition indicative of an impact event and is configured to cause the actuator to move the member from the first position to the second position in response to the at least one condition indicative of an impact event.

### TECHNICAL FIELD

This invention relates to vehicles having members that are deployable in response to, or in anticipation of, a side impact event.

### BACKGROUND OF THE INVENTION

Prior art vehicles include a vehicle body that defines a passenger compartment. Typically, the sides of the vehicle body are characterized by doors that, when closed, obstruct openings to the passenger compartment and, when open, permit access to the passenger compartment from the exterior of the vehicle body.

Prior art vehicles may include doors having impact beams therein to receive a load from an object impacting the side of the vehicle body. Prior art vehicles may also include side mounted airbags for use during an impact to the side of the vehicle body.

### SUMMARY OF THE INVENTION

A vehicle includes a vehicle body. At least one member is mounted with respect to the vehicle body and is selectively movable between first and second positions with respect to the vehicle body. An actuator has an active material that is configured to undergo a change in at least one attribute in response to an activation signal. The active material is operatively connected to the member such that the change in at least one attribute causes the member to move relative to the vehicle body. The vehicle further includes an impact detection system that is configured to detect at least one condition indicative of an impact event, and to cause the actuator to move the member from the first position to the second position in response to detecting the at least one condition indicative of an occurring or impending impact event.

The member may be stowed in the first position, and deployed in the second position to absorb energy from a side impact, increase structural integrity in a side impact, etc. The active material based actuator may provide reduced cost, reduced mass, reduced packaging volume, and quieter operation compared to prior art actuators. The active material based actuator also enables reversible operation, which in turn enables the use of pre-impact sensors in the impact detection system, because if the impact detection system detects a condition indicative of an impact, but no impact actually occurs, then the member is readily retractable to its stowed position.

A method is also provided. The method includes detecting at least one condition indicative of an impact event to a vehicle body, and transmitting an activation signal to an active material in response to detecting at least one condition indicative of an impact event to a vehicle body. The active material is configured to undergo a change in at least one attribute in response to an activation signal, and is operatively connected to a member such that the change in at least one attribute causes the member to move from a first position to a second position with respect to the vehicle body.

The above features and advantages and other features and advantages of the present invention are readily apparent from the following detailed description of the best modes for carrying out the invention when taken in connection with the accompanying drawings.

### BRIEF DESCRIPTION OF THE DRAWINGS

FIG. 1 is a schematic elevation view of a motor vehicle body including a side impact protection system;

FIG. 2 is a sectional view taken along the line 2-2 of FIG. 1 illustrating the side impact protection system in a stowed configuration;

FIG. 3 is a sectional view taken along the line 2-2 of FIG. 1 illustrating the side impact protection system in a deployed configuration;

FIG. 4 is a perspective view of the side impact protection system in the deployed configuration;

FIG. 5 is an enlarged view of a cable employed in the side impact protection system of FIGS. 1-4;

FIG. 6 is a sectional view of the cable of FIG. 5 taken along the line 6-6;

FIG. 7 is a perspective view of an exemplary L-shaped structure for use in the side impact protection system of FIG. 1;

FIG. 8A is a schematic, perspective view of deceleration delimiting device including a selectively expandable member in a stowed position;

FIG. 8B is a schematic, perspective view of the deceleration delimiting device of FIG. 8A with the selectively expandable member in an expanded position;

FIG. 9 is a schematic front view of a vehicle including two laterally movable seat assemblies;

FIG. 10A is a schematic front view of a vehicle including a lateral deployment system having a plurality of members in respective first positions;

FIG. 10B is a schematic, front view of the vehicle of FIG. 10A with the plurality of members in respective second positions cooperating to define a cross-car beam; and

FIG. 11 is a schematic depiction of an impact deployment system.

### DESCRIPTION OF THE PREFERRED EMBODIMENTS

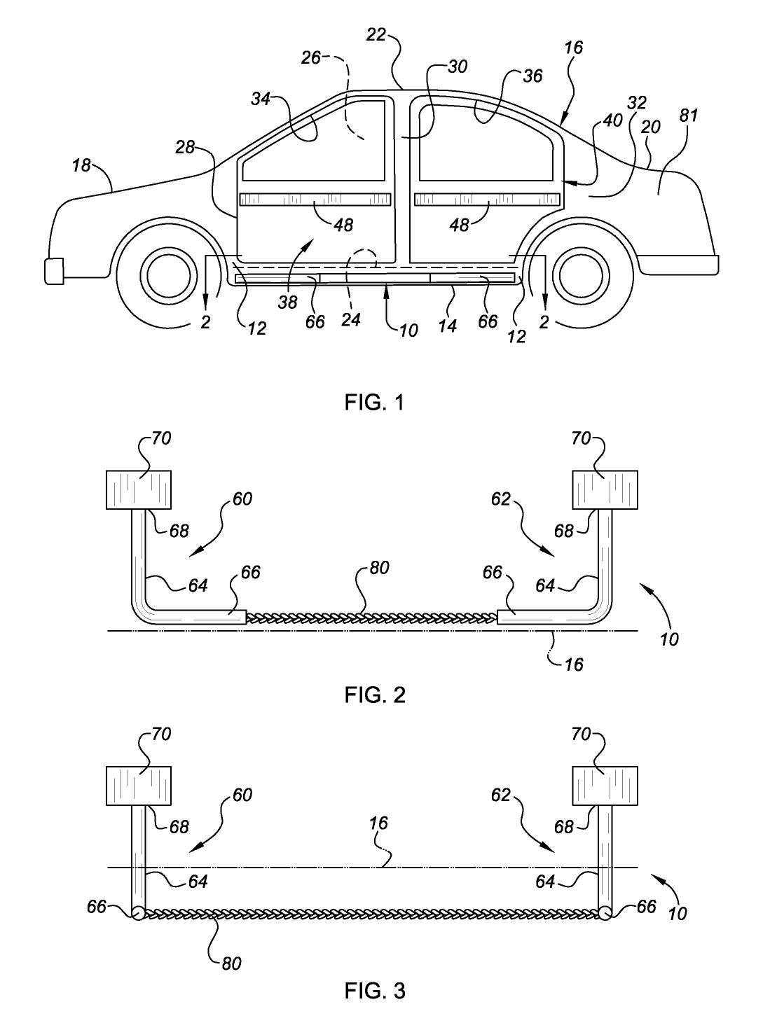

Referring to FIG. 1, there is shown an exemplary side impact protection system, generally designated by reference numeral 10, for use in a motor vehicle body 16. The side impact protection system 10 is preferably disposed in rocker regions 12 at about a floorpan 14 of the motor vehicle body 16.

The motor vehicle body depicted 16 generally includes a front sheet metal portion 18, a rear sheet metal portion 20, a roof 22, and a floor 24 which cooperate in defining therebetween an interior compartment 26 of the vehicle body 16. The vehicle body 16 further includes A pillars 28, B pillars 30, and C pillars 32. The A and B pillars 28, 30 define vertical front and rear edges, respectively, of respective ones of a pair of front door frames 34 on opposite sides of the vehicle body 16 for access to the interior compartment 26. The B and C pillars 30, 32 define vertical front and rear edges, respectively, of respective ones of a pair of rear door frames 36 on opposite sides of the vehicle body for access to the passenger compartment 26.

The floorpan 14 with various crossbeam structural members generally spans longitudinally with respect to the vehicle from about the A pillar 28 to about the C pillar 32 and laterally across the vehicle from rocker region to rocker, and as such, may form part of the vehicle chassis. The vehicle body 16 in the embodiment depicted includes a pair of front doors 38 mounted via hinges (not shown) to respective A pillars 28, and a pair of rear doors 40 mounted via hinges (not shown) to respective B pillars 30. Each front and rear door 38, 40 includes a respective horizontal steel beam 48, as understood by those skilled in the art.

Referring to FIGS. 2 and 3, the side impact protection system 10 generally includes two L-shaped structures 60, 62, each including a first straight portion 64 perpendicularly oriented with respect to a second straight portion 66. An end 68 of each first straight portion 64 is operatively connected to an active materials based actuator 70. Each actuator 70 is fixedly attached to the vehicle body 16 for deploying the system 10. When the system 10 is in a stowed configuration, as shown in FIGS. 1 and 2, portions 64 are in a retracted position with respect to the vehicle body 16, and both portions 66 of the two L-shaped structures 60, 62 are generally horizontally oriented. Structures 60, 62 do not protrude laterally from the vehicle body 16.

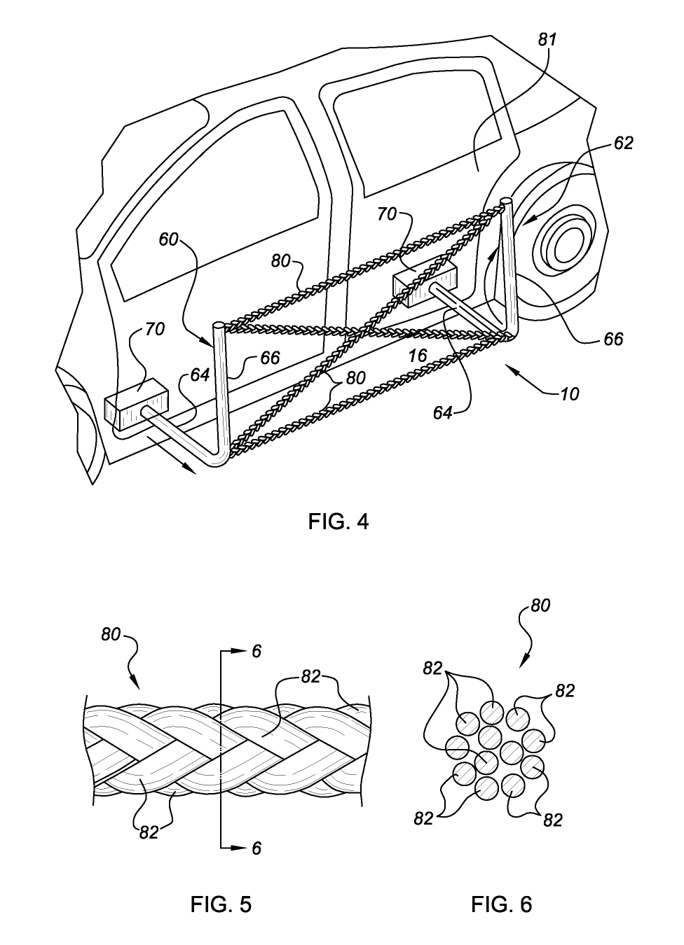

During deployment, actuators 70 move the first portions 64 laterally outward from their retracted positions to extended positions with respect to the vehicle body 16, and the second portions 66 are moved laterally outward and rotate to a substantially upright position in which portions 66 are generally vertically oriented, as shown in FIGS. 3 and 4. Thus, when the system 10 is in the deployed configuration, as shown in FIGS. 3 and 4, the second portions 66 and part of the first portions 64 protrude laterally from the vehicle body 16.

A plurality of synthetic cables 80 is fixedly attached to the second portions 66. Upon deployment of system 10, the synthetic cables 80 become substantially taut upon rotation of the second portions 66 to the upright position so as to form an X pattern in the vertical plane parallel to the side 81 of the vehicle body 16 as shown in FIG. 4. In this manner, when the system 10 is deployed, the synthetic cables 80 act as a barrier to the interior compartment 26 of the vehicle body 16. Although an X pattern is shown, a variety of patterns can be employed and is well within the skill of those in the art to optimize the cable arrangement to suit the particular application.

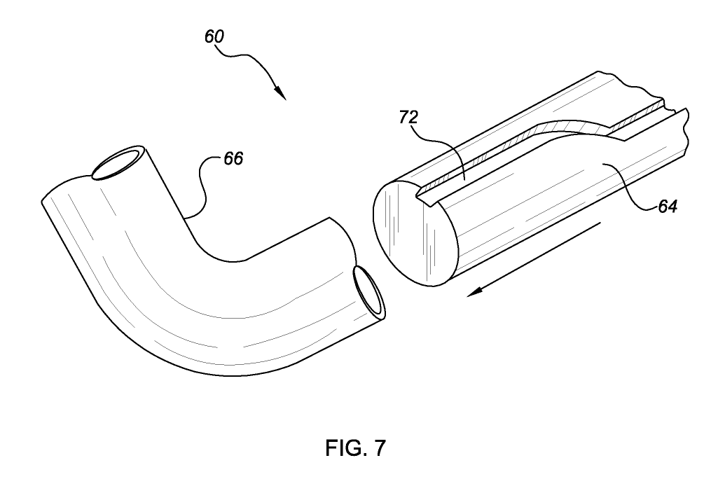

Referring to FIG. 7, wherein like reference numbers refer to like components from FIGS. 1-4, rotation of the second portion 66 to the upright position can be effected with a slot-type guide having an initial non-threaded portion at an end of the second portion 66 for engagement with the first portion 64. The housing for the slot type guide or the car structure itself would include a pin for sliding engagement with the slot 72 formed in the first portion 64. A mechanical locking mechanism such as a ratchet type device would hold the first portion 64 in this position and prevent further rotation until deactivated. In this manner, the first portion 64 first moves outwardly away from the vehicle body 16 prior to rotation of the second portion 66 to an upright position such that upon rotation of the second portions 66, clearance from the exterior of the vehicle body 16 occurs.

Referring to FIGS. 5 and 6, wherein like reference numbers refer to like components from FIGS. 1-4, the synthetic cables 80 are preferably made of filaments of a synthetic material exhibiting high elongational stiffness and high strain-at-failure. Such cables provide non-catastrophic failure modes at very high strains as compared to the low strain catastrophic failure mode of cables formed of steel. Exemplary synthetic materials include Kevlar 29 aramid fibers available from the Dupont Corporation and a high performance thermoplastic multi-filament yarn spun from Vectrae®, a liquid crystal polymer available from the Hoechst Celanese Corporation. Kevlar 29 and Vectrae® are materials having densities of about 1.4 g/cc and are light weight relative to steel having a density of about 7.7 g/cc. Kevlar 29 and Vectra® also exhibit high strain-at-failure, i.e., 3.6% and 3.3%, respectively, relative to the stain-at-failure for steel wire, i.e., 1.1%. As shown in FIGS. 5 and 6, each synthetic cable 80 is comprised of filaments that are preferably grouped into a plurality of multi-filament bundles 82, which bundles are helically braided. Synthetic cables, which performed satisfactorily in experimental tests, consisted of 12 multi-filament bundles, each cable having a diameter of about 1.27 cm.

Upon impact, the synthetic cables 80 become extremely stiff in tension and transfer the impact forces to the A, B, and C pillars as well as to the car cross beams connected to the floorpan 14 and vehicle chassis; the impact forces thus accelerate the vehicle body away from the impact. The effective high strain-at-failure capability of the synthetic cables 80 of about 13%, attributable to about 3% elongation of the individual synthetic fibers and about 10% elongation attributable to the helical braid of the bundles 82, permits each synthetic cable to elongate inelastically.

The actuator 70 functions to cooperatively and simultaneously laterally extend the first portions 64 of the L-shaped structures 60, 62 from the vehicle body. Once clearance from the doors 38, 40 is achieved, the second portions 66 rotate to the upright position.

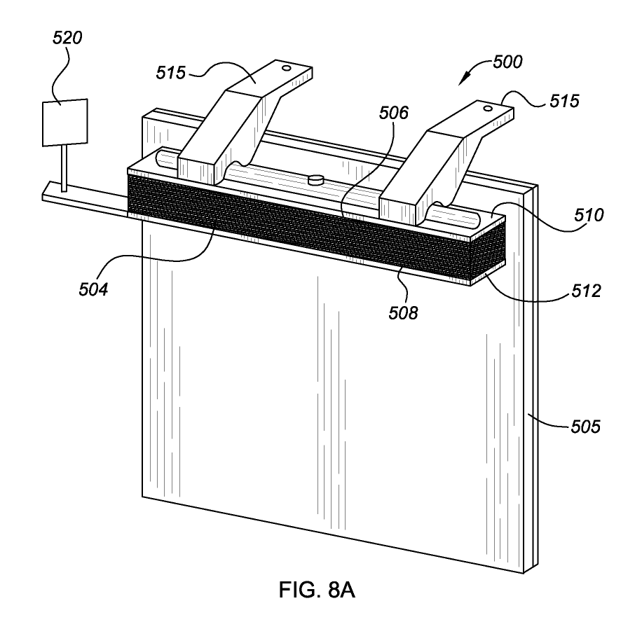

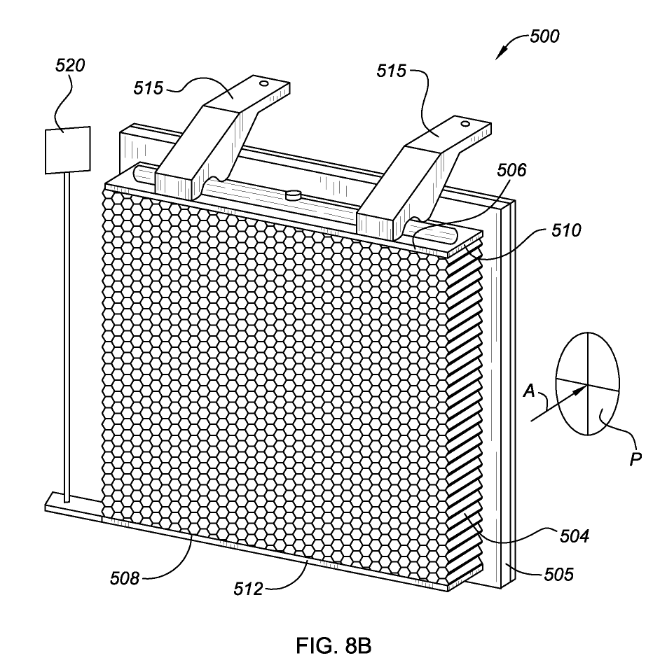

Referring to FIG. 8A, a force and deceleration delimiting device 500 is schematically depicted. The device 500 includes a honeycomb or other shaped cellular structure 504 abutting a generally vertically oriented wall 505. The wall 505 preferably forms portion of the side of the vehicle body (shown at 16 in FIG. 1). The honeycomb cellular structure 504 terminates at an upper face 506 and a lower face 508. Attached (such as, for example, by an adhesive) to the upper and lower faces 506, 508 are end cap members 510, 512, respectively. The end cap members 510, 512 are substantially rigid. The structure 504 is shown in a compacted, stowed position in FIG. 8A. In the stowed position, the structure 504 occupies a first volume.

The device 500 also includes two brackets 515, which are mounted to the vehicle body and which support the upper end cap member 510. The lower end cap member 512 is operatively connected to an active-materials based actuator 520. The actuator 520 is configured to selectively move the lower end cap 512 downward and away from the upper end cap member 510, thereby expanding the honeycomb cellular structure 504 to the expanded position shown in FIG. 8B. In the expanded position, the structure 504 occupies a second volume greater than the first volume.

Referring to FIG. 8B, the expansion of honeycomb cellular structure 504 is in a generally vertical plane P, which is generally perpendicularly oriented to an anticipated side impact axis A. The impact axis A is transversely oriented with respect to the vehicle body (shown at 16 in FIG. 1). The device 500 is thus compact until activated, and the structure 504, when expanded is configured to absorb impact energy via plastic deformation. Although the cells of the structure 504 are honeycomb-shaped in the embodiment depicted, other cell shapes and configurations that permit compression and expansion in the manner described herein may be employed within the scope of the claimed invention. In one embodiment, the honeycomb cellular structure 504 is formed of a lightweight metallic material, e.g., aluminum. Those skilled in the art will recognize a variety of other materials that may be used to form the structure 504 within the scope of the claimed invention, such as nylon, cellulose, etc. The material composition and cell geometries will be determined by the desired application.

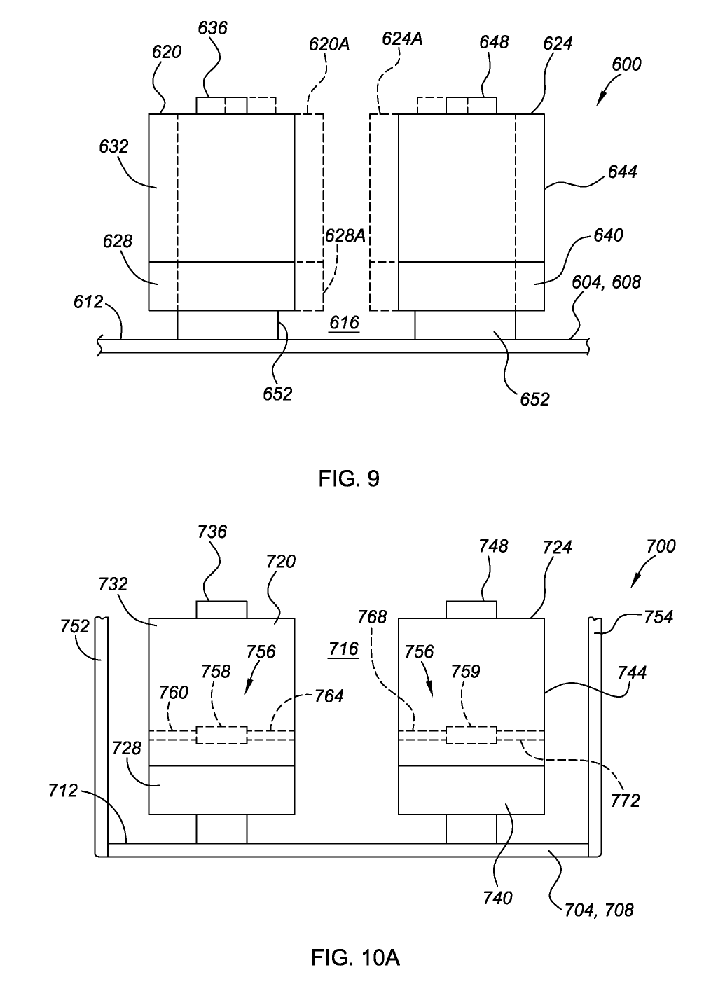

Referring to FIG. 9, a vehicle 600 includes a vehicle body 604. The vehicle body 604 includes a floor 608 having an upper surface 612. The upper surface 612 defines the lower extent of an interior compartment 616. The vehicle body 604 includes two seat assemblies 620, 624. Seat assembly 620 includes a lower seat portion 628, a seatback portion 632 mounted with respect to the lower seat portion 628, and a head restraint 636 mounted with respect to the seatback portion 632, as understood by those skilled in the art. Seat assembly 624 includes a lower seat portion 640, a seatback portion 644 mounted with respect to the lower seat portion 640, and a head restraint 648 mounted with respect to the seatback portion 644, as understood by those skilled in the art. The seat assemblies 620, 624 are supported above the floor 608 within the interior compartment 616 for supporting human passengers (not shown).

Seat assembly 620 is slidably connected to the floor 608, such as via a transversely oriented track (not shown) such that the seat assembly 620 is selectively movable between an outboard position, as shown at 620, and an inboard position, as shown in phantom at 620A. Similarly, seat assembly 624 is slidably connected to the floor 608, such as via a transversely oriented track (not shown) such that the seat assembly 624 is selectively movable between an outboard position, as shown at 624, and an inboard position, as shown in phantom at 624A.

The vehicle 600 includes two active material based actuators 652. One of the actuators 652 is configured to selectively move seat assembly 620 between its outboard and inboard positions, and the other actuator 652 is configured to selectively move seat assembly 624 between its outboard and inboard positions.

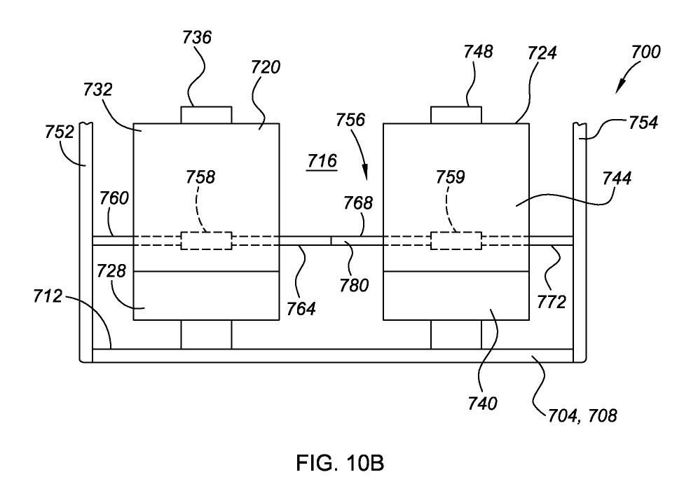

Referring to FIG. 10A, vehicle 700 includes a vehicle body 704. The vehicle body 704 includes a vehicle floor 708 having an upper surface 712. The upper surface 712 partially defines an interior compartment 716. Two seat assemblies 720, 724 are mounted with respect to the floor 708 within the interior compartment 716. Seat assembly 720 includes a lower seat portion 728, a seatback portion 732 mounted with respect to the lower seat portion 728, and a head restraint 736 mounted with respect to the seatback portion 732, as understood by those skilled in the art. Seat assembly 724 includes a lower seat portion 740, a seatback portion 744 mounted with respect to the lower seat portion 740, and a head restraint 748 mounted with respect to the seatback portion 744, as understood by those skilled in the art. The body 704 further includes two vertical pillars, such as B pillars 752, 754 that are mounted with respect to the floor 708 on opposite sides of the interior compartment 716.

The vehicle 700 includes a lateral deployment system 756. The lateral deployment system 756 includes two active material based actuators 758, 759; actuator 758 is contained within seatback portion 732, and actuator 759 is contained within seatback portion 744. The lateral deployment system 756 also includes a plurality of selectively extendable members 760, 764, 768, 772. The members 760, 764, 768, 772 are colinearly aligned. The lateral deployment system 756 is characterized by a stowed configuration, as shown in FIG. 10A, in which the members 760, 764, 768, 772 are entirely located within seatback portions 732, 744. More specifically, members 760, 764 are within seatback portion 732, and members 768, 772 are within seatback portion 744.

Members 760, 764 are operatively connected to actuator 758 and members 768, 772 are operatively connected to actuator 759. Actuators 758, 759 are configured to selectively move the system 756 from the stowed configuration, as shown in FIG. 10A, to a deployed configuration as shown in FIG. 10B. Referring to FIG. 10B, during deployment, actuator 758 moves member 760 outboard until the member 760 abuts B pillar 752; actuator 758 moves member 764 inboard, and actuator 759 moves member 768 inboard until member 764 and member 768 abut one another; and actuator 759 moves member 772 outboard until member 759 abuts B pillar 754. Thus, when the system 756 is in its deployed configuration, member 760, actuator 758, member 764, member 768, actuator 759, and member 772 cooperate to form a cross-car beam 780 that is configured to transfer side impact loads from one side of the vehicle body 704 to the other.

More than two actuators may be employed in moving the members 760, 764, 768, 772 within the scope of the claimed invention. Other components may cooperate with the members 760, 764, 768, 772 to define the cross-car beam 780. For example, if a center console (not shown) is between the seat assemblies 720, 724, members 764 and 768 may abut the center console such that the center console forms a portion of the cross-car beam and transfers side impact loads.

Members 760, 764, 768, 772 may be characterized by any geometry; for example, members 760, 764, 768, 772 may have hollow or solid cross sections, have a circular, prismatic, arbitrary, or other cross sections, etc. Members 760, 764, 768, 772 may also include telescoping sections within the scope of the claimed invention.

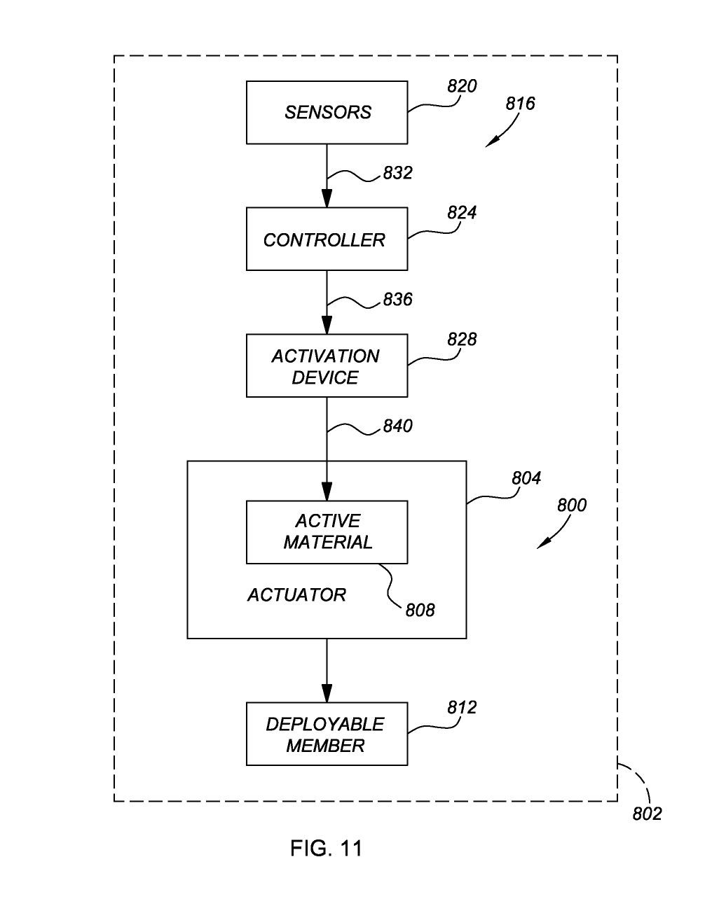

Referring to FIG. 11, a side impact deployment apparatus 800 in a vehicle body 802 is schematically depicted. The apparatus includes an active material based actuator 804, which includes active material 808. The active material based actuator 804 is operatively connected to a selectively movable member 812.

The apparatus 800 is representative of the system shown at 10 in FIGS. 1-4, the force and deceleration delimiting device shown at 500 in FIGS. 8A and 8B, the movable seat assemblies shown at 620 and 624 in FIG. 9, and the lateral deployment system shown at 756 in FIGS. 10A and 10B.

Thus, if apparatus 800 represents the system shown at 10 in FIGS. 1-4, then actuator 804 represents the actuators shown at 70 in FIGS. 2-4, and the member 812 represents the portions 64 of structures 60, 62 in FIGS. 2-4. If apparatus 800 represents the force and deceleration delimiting device shown at 500 in FIGS. 8A and 8B, then actuator 804 represents the actuator shown at 520 in FIGS. 8A and 8B, and the member 812 represents the lower end cap shown at 512 in FIGS. 8A and 8B. If apparatus 800 represents the movable seat assemblies shown at 620 and 624 in FIG. 9, then actuator 804 represents one of the actuators shown at 652 in FIG. 9, and member 812 represents one or both of the seats shown at 620, 624 in FIG. 9. If apparatus 800 represents the lateral deployment system shown at 756 in FIGS. 10A and 10B, then actuator 804 represents one or both of the actuators shown at 758, 759 in FIGS. 10A and 10B, and member 812 represents one or more of the members shown at 760, 764, 768, 772 in FIGS. 10A and 10B.

The apparatus 800 is operatively connected to an impact detection system 816 that is configured to detect at least one condition indicative of an impact event and to cause the actuator 804 to move the member 812 from a first position to a second position in response to detecting at least one condition that is indicative of an impact event. In the first position, the member 812 is stowed. In the second position, the member 812 is deployed or expanded. An impact event is an object impacting the vehicle body 802, and may include frontal, rear, and lateral (side) impacts within the scope of the claimed invention. A condition that is indicative of an impact event is indicative of an actual impact to the vehicle body 802 or is indicative of an elevated risk of an impact to the vehicle body 802.

In an exemplary embodiment, the impact detection system 816 is configured to detect at least one condition indicative of a side impact event and to cause the actuator 804 to move the member 812 from the first position to the second position in response to detecting at least one condition that is indicative of a side impact event. A side impact event is an object impacting a lateral surface of the vehicle body 802. A condition that is indicative of a side impact event is indicative of an actual impact to a lateral surface of the vehicle body 802 or is indicative of an elevated risk of an impact to a lateral surface of the vehicle body 802. Exemplary conditions indicative of an actual impact include lateral acceleration of the vehicle body 802 exceeding a predetermined amount, displacement of a lateral portion of the body 802 relative to the center portion of the body 802, etc. Exemplary conditions indicative of an elevated risk of an impact include an object being less than a predetermined combination of relative velocity and distance from a lateral surface of the vehicle body 802, etc.

The impact detection system 816 includes sensors 820, a controller 824, and an activation device 828. The sensors 820 are configured to monitor conditions of the vehicle body 802, which may include conditions of the operating environment of the vehicle body 802, and to transmit sensor signals 832 indicative of the conditions to the controller 824. Exemplary sensors 820 include accelerometers configured to monitor lateral acceleration of the vehicle body 802, radar sensors configured to monitor the position and movement of objects relative to the vehicle body 802, vehicle to vehicle and vehicle to infrastructure communication, map and GPS based location and object proximity identification systems, etc.

The controller 824 is configured to analyze the sensor signals 832 according to a preprogrammed algorithm to determine whether the conditions monitored by sensors 820 are indicative of a side impact event, as understood by those skilled in the art. Accordingly, the impact detection system 816 is configured to detect conditions indicative of a side impact event. The controller 824 is configured to transmit a control signal 836 to the activation device 828 if the controller 824 determines that at least one condition indicative of a side impact event is present. The activation device 828 is configured to transmit, in response to receiving control signal 836, an activation signal 840 to the active material 808. The active material 808 is configured to undergo a change in at least one attribute in response to the activation signal 836. The active material 808 is operatively connected to member 812 such that the change in at least one attribute causes the member 812 to move from the first position to the second position. Thus, the activation signal 836 causes movement of the member 812. Exemplary material attributes that change in response to the activation signal 832 include, but are not limited to, dimensions, shape, stiffness (elastic or flexural modulus), etc. The activation signal provided by the activation device 828 may include a heat signal, a magnetic signal, an electrical signal, a pneumatic signal, a mechanical signal, and the like, and combinations comprising at least one of the foregoing signals, with the particular activation signal dependent on the materials and/or configuration of the active material.

For example, a magnetic and/or an electrical signal may be applied for changing the property of an active material fabricated from magnetostrictive materials. A heat signal may be applied for changing the property of an active material fabricated from shape memory alloys and/or shape memory polymers. An electrical signal may be applied for changing the property of an active material fabricated from electroactive materials, piezoelectrics, electrostatics, and/or ionic polymer metal composite materials.

Suitable active materials include, without limitation, shape memory alloys (SMA), shape memory polymers (SMP), piezoelectric materials, electroactive polymers (EAP), ferromagnetic materials, magnetorheological fluids and elastomers (MR) and electrorheological fluids and elastomers (ER).

Suitable shape memory alloys can exhibit a one-way shape memory effect, an intrinsic two-way effect, or an extrinsic two-way shape memory effect depending on the alloy composition and processing history. The two phases that occur in shape memory alloys are often referred to as martensite and austenite phases. The martensite phase is a relatively soft and easily deformable phase of the shape memory alloys, which generally exists at lower temperatures. The austenite phase, the stronger phase of shape memory alloys, occurs at higher temperatures. Shape memory materials formed from shape memory alloy compositions that exhibit one-way shape memory effects do not automatically reform, and depending on the shape memory material design, will likely require an external mechanical force to reform the shape orientation that was previously exhibited. Shape memory materials that exhibit an intrinsic shape memory effect are fabricated from a shape memory alloy composition that will automatically reform themselves.

The temperature at which the shape memory alloy remembers its high temperature form when heated can be adjusted by slight changes in the composition of the alloy and through heat treatment. In nickel-titanium shape memory alloys, for example, it can be changed from above about 100° C. to below about −100° C. The shape recovery process occurs over a range of just a few degrees and the start or finish of the transformation can be controlled to within a degree or two depending on the desired application and alloy composition. The mechanical properties of the shape memory alloy vary greatly over the temperature range spanning their transformation, typically providing the shape memory material with shape memory effects as well as high damping capacity. The inherent high damping capacity of the shape memory alloys can be used to further increase the energy absorbing properties.

Suitable shape memory alloy materials include without limitation nickel-titanium based alloys, indium-titanium based alloys, nickel-aluminum based alloys, nickel-gallium based alloys, copper based alloys (e.g., copper-zinc alloys, copper-aluminum alloys, copper-gold, and copper-tin alloys), gold-cadmium based alloys, silver-cadmium based alloys, indium-cadmium based alloys, manganese-copper based alloys, iron-platinum based alloys, iron-platinum based alloys, iron-palladium based alloys, and the like. The alloys can be binary, ternary, or any higher order so long as the alloy composition exhibits a shape memory effect, e.g., change in shape orientation, damping capacity, and the like.

Other suitable active materials are shape memory polymers. Similar to the behavior of a shape memory alloy, when the temperature is raised through its transition temperature, the shape memory polymer also undergoes a change in shape orientation. Dissimilar to SMAs, raising the temperature through the transition temperature causes a substantial drop in modulus. While SMAs are well suited as actuators, SMPs are better suited as “reverse” actuators. That is, by undergoing a large drop in modulus by heating the SMP past the transition temperature, release of stored energy blocked by the SMP in its low temperature high modulus form can occur. To set the permanent shape of the shape memory polymer, the polymer must be at about or above the Tg or melting point of the hard segment of the polymer. “Segment” refers to a block or sequence of polymer forming part of the shape memory polymer. The shape memory polymers are shaped at the temperature with an applied force followed by cooling to set the permanent shape. The temperature necessary to set the permanent shape is preferably between about 100° C. to about 300° C. Setting the temporary shape of the shape memory polymer requires the shape memory polymer material to be brought to a temperature at or above the Tg or transition temperature of the soft segment, but below the Tg or melting point of the hard segment. At the soft segment transition temperature (also termed “first transition temperature”), the temporary shape of the shape memory polymer is set followed by cooling of the shape memory polymer to lock in the temporary shape. The temporary shape is maintained as long as it remains below the soft segment transition temperature. The permanent shape is regained when the shape memory polymer fibers are once again brought to or above the transition temperature of the soft segment. Repeating the heating, shaping, and cooling steps can reset the temporary shape. The soft segment transition temperature can be chosen for a particular application by modifying the structure and composition of the polymer. Transition temperatures of the soft segment range from about −63° C. to above about 120° C.

Shape memory polymers may contain more than two transition temperatures. A shape memory polymer composition comprising a hard segment and two soft segments can have three transition temperatures: the highest transition temperature for the hard segment and a transition temperature for each soft segment.

Most shape memory polymers exhibit a “one-way” effect, wherein the shape memory polymer exhibits one permanent shape. Upon heating the shape memory polymer above the first transition temperature, the permanent shape is achieved and the shape will not revert back to the temporary shape without the use of outside forces. As an alternative, some shape memory polymer compositions can be prepared to exhibit a “two-way” effect. These systems consist of at least two polymer components. For example, one component could be a first cross-linked polymer while the other component is a different cross-linked polymer. The components are combined by layer techniques, or are interpenetrating networks, wherein two components are cross-linked but not to each other. By changing the temperature, the shape memory polymer changes its shape in the direction of the first permanent shape of the second permanent shape. Each of the permanent shapes belongs to one component of the shape memory polymer. The two permanent shapes are always in equilibrium between both shapes. The temperature dependence of the shape is caused by the fact that the mechanical properties of one component (“component A”) are almost independent from the temperature in the temperature interval of interest. The mechanical properties of the other component (“component B”) depend on the temperature. In one embodiment, component B becomes stronger at low temperatures compared to component A, while component A is stronger at high temperatures and determines the actual shape. A two-way memory device can be prepared by setting the permanent shape of component A (“first permanent shape”); deforming the device into the permanent shape of component B (“second permanent shape”) and fixing the permanent shape of component B while applying a stress to the component.

Similar to the shape memory alloy materials, the shape memory polymers can be configured in many different forms and shapes. The temperature needed for permanent shape recovery can be set at any temperature between about −63° C. and about 120° C. or above. Engineering the composition and structure of the polymer itself can allow for the choice of a particular temperature for a desired application. A preferred temperature for shape recovery is greater than or equal to about −30° C., more preferably greater than or equal to about 0° C., and most preferably a temperature greater than or equal to about 50° C. Also, a preferred temperature for shape recovery is less than or equal to about 120° C., more preferably less than or equal to about 90° C., and most preferably less than or equal to about 70° C.

Suitable shape memory polymers include thermoplastics, thermosets, interpenetrating networks, semi-interpenetrating networks, or mixed networks. The polymers can be a single polymer or a blend of polymers. The polymers can be linear or branched thermoplastic elastomers with side chains or dendritic structural elements. Suitable polymer components to form a shape memory polymer include, but are not limited to, polyphosphazenes, poly(vinyl alcohols), polyamides, polyester amides, poly(amino acid)s, polyanhydrides, polycarbonates, polyacrylates, polyalkylenes, polyacrylamides, polyalkylene glycols, polyalkylene oxides, polyalkylene terephthalates, polyortho esters, polyvinyl ethers, polyvinyl esters, polyvinyl halides, polyesters, polylactides, polyglycolides, polysiloxanes, polyurethanes, polyethers, polyether amides, polyether esters, and copolymers thereof. Examples of suitable polyacrylates include poly(methyl methacrylate), poly(ethyl methacrylate), ply(butyl methacrylate), poly(isobutyl methacrylate), poly(hexyl methacrylate), poly(isodecyl methacrylate), poly(lauryl methacrylate), poly(phenyl methacrylate), poly(methyl acrylate), poly(isopropyl acrylate), poly(isobutyl acrylate) and poly(octadecyl acrylate). Examples of other suitable polymers include polystyrene, polypropylene, polyvinyl phenol, polyvinylpyrrolidone, chlorinated polybutylene, poly(octadecyl vinyl ether) ethylene vinyl acetate, polyethylene, poly(ethylene oxide)-poly(ethylene terephthalate), polyethylene/nylon (graft copolymer), polycaprolactones-polyamide (block copolymer), poly(caprolactone) dimethacrylate-n-butyl acrylate, poly(norbornyl-polyhedral oligomeric silsequioxane), polyvinylchloride, urethane/butadiene copolymers, polyurethane block copolymers, styrene-butadiene-styrene block copolymers, and the like.

The shape memory polymer or the shape memory alloy, may be activated by any suitable means, preferably a means for subjecting the material to a temperature change above, or below, a transition temperature. For example, for elevated temperatures, heat may be supplied using hot gas (e.g., air), steam, hot liquid, or electrical current. The activation means may, for example, be in the form of heat conduction from a heated element in contact with the shape memory material, heat convection from a heated conduit in proximity to the thermally active shape memory material, a hot air blower or jet, microwave interaction, resistive heating, and the like. In the case of a temperature drop, heat may be extracted by using cold gas, or evaporation of a refrigerant. The activation means may, for example, be in the form of a cool room or enclosure, a cooling probe having a cooled tip, a control signal to a thermoelectric unit, a cold air blower or jet, or means for introducing a refrigerant (such as liquid nitrogen) to at least the vicinity of the shape memory material.

Suitable magnetic materials include, but are not intended to be limited to, soft or hard magnets; hematite; magnetite; magnetic material based on iron, nickel, and cobalt, alloys of the foregoing, or combinations comprising at least one of the foregoing, and the like. Alloys of iron, nickel and/or cobalt, can comprise aluminum, silicon, cobalt, nickel, vanadium, molybdenum, chromium, tungsten, manganese and/or copper.

Suitable MR fluid materials include, but are not intended to be limited to, ferromagnetic or paramagnetic particles dispersed in a carrier fluid. Suitable particles include iron; iron alloys, such as those including aluminum, silicon, cobalt, nickel, vanadium, molybdenum, chromium, tungsten, manganese and/or copper; iron oxides, including Fe2O3 and Fe3O4; iron nitride; iron carbide; carbonyl iron; nickel and alloys of nickel; cobalt and alloys of cobalt; chromium dioxide; stainless steel; silicon steel; and the like. Examples of suitable particles include straight iron powders, reduced iron powders, iron oxide powder/straight iron powder mixtures and iron oxide powder/reduced iron powder mixtures. A preferred magnetic-responsive particulate is carbonyl iron, preferably, reduced carbonyl iron.

The particle size should be selected so that the particles exhibit multi-domain characteristics when subjected to a magnetic field. Average dimension sizes for the particles can be less than or equal to about 1,000 micrometers, with less than or equal to about 500 micrometers preferred, and less than or equal to about 100 micrometers more preferred. Also preferred is a particle dimension of greater than or equal to about 0.1 micrometer, with greater than or equal to about 0.5 more preferred, and greater than or equal to about 10 micrometers especially preferred. The particles are preferably present in an amount between about 5.0 to about 50 percent by volume of the total MR fluid composition.

Suitable carrier fluids include organic liquids, especially non-polar organic liquids. Examples include, but are not limited to, silicone oils; mineral oils; paraffin oils; silicone copolymers; white oils; hydraulic oils; transformer oils; halogenated organic liquids, such as chlorinated hydrocarbons, halogenated paraffins, perfluorinated polyethers and fluorinated hydrocarbons; diesters; polyoxyalkylenes; fluorinated silicones; cyanoalkyl siloxanes; glycols; synthetic hydrocarbon oils, including both unsaturated and saturated; and combinations comprising at least one of the foregoing fluids.

The viscosity of the carrier component can be less than or equal to about 100,000 centipoise, with less than or equal to about 10,000 centipoise preferred, and less than or equal to about 1,000 centipoise more preferred. Also preferred is a viscosity of greater than or equal to about 1 centipoise, with greater than or equal to about 250 centipoise preferred, and greater than or equal to about 500 centipoise especially preferred.

Aqueous carrier fluids may also be used, especially those comprising hydrophilic mineral clays such as bentonite or hectorite. The aqueous carrier fluid may comprise water or water comprising a small amount of polar, water-miscible organic solvents such as methanol, ethanol, propanol, dimethyl sulfoxide, dimethyl formamide, ethylene carbonate, propylene carbonate, acetone, tetrahydrofuran, diethyl ether, ethylene glycol, propylene glycol, and the like. The amount of polar organic solvents is less than or equal to about 5.0% by volume of the total MR fluid, and preferably less than or equal to about 3.0%. Also, the amount of polar organic solvents is preferably greater than or equal to about 0.1%, and more preferably greater than or equal to about 1.0% by volume of the total MR fluid. The pH of the aqueous carrier fluid is preferably less than or equal to about 13, and preferably less than or equal to about 9.0. Also, the pH of the aqueous carrier fluid is greater than or equal to about 5.0, and preferably greater than or equal to about 8.0.

Natural or synthetic bentonite or hectorite may be used. The amount of bentonite or hectorite in the MR fluid is less than or equal to about 10 percent by weight of the total MR fluid, preferably less than or equal to about 8.0 percent by weight, and more preferably less than or equal to about 6.0 percent by weight. Preferably, the bentonite or hectorite is present in greater than or equal to about 0.1 percent by weight, more preferably greater than or equal to about 1.0 percent by weight, and especially preferred greater than or equal to about 2.0 percent by weight of the total MR fluid.

Optional components in the MR fluid include clays, organoclays, carboxylate soaps, dispersants, corrosion inhibitors, lubricants, extreme pressure anti-wear additives, antioxidants, thixotropic agents and conventional suspension agents. Carboxylate soaps include ferrous oleate, ferrous naphthenate, ferrous stearate, aluminum di- and tri-stearate, lithium stearate, calcium stearate, zinc stearate and sodium stearate, and surfactants such as sulfonates, phosphate esters, stearic acid, glycerol monooleate, sorbitan sesquioleate, laurates, fatty acids, fatty alcohols, fluoroaliphatic polymeric esters, and titanate, aluminate and zirconate coupling agents and the like. Polyalkylene diols, such as polyethylene glycol, and partially esterified polyols can also be included.

Suitable MR elastomer materials include, but are not intended to be limited to, an elastic polymer matrix comprising a suspension of ferromagnetic or paramagnetic particles, wherein the particles are described above. Suitable polymer matrices include, but are not limited to, poly-alpha-olefins, natural rubber, silicone, polybutadiene, polyethylene, polyisoprene, and the like.

Electroactive polymers include those polymeric materials that exhibit piezoelectric, pyroelectric, or electrostrictive properties in response to electrical or mechanical fields. The materials generally employ the use of compliant electrodes that enable polymer films to expand or contract in the in-plane directions in response to applied electric fields or mechanical stresses. An example of an electrostrictive-grafted elastomer with a piezoelectric poly(vinylidene fluoride-trifluoro-ethylene) copolymer. This combination has the ability to produce a varied amount of ferroelectric-electrostrictive molecular composite systems. These may be operated as a piezoelectric sensor or even an electrostrictive actuator. Activation of an EAP based pad preferably utilizes an electrical signal to provide change in shape orientation sufficient to provide displacement. Reversing the polarity of the applied voltage to the EAP can provide a reversible lockdown mechanism.

Materials suitable for use as the electroactive polymer may include any substantially insulating polymer or rubber (or combination thereof) that deforms in response to an electrostatic force or whose deformation results in a change in electric field. Exemplary materials suitable for use as a pre-strained polymer include silicone elastomers, acrylic elastomers, polyurethanes, thermoplastic elastomers, copolymers comprising PVDF, pressure-sensitive adhesives, fluoroelastomers, polymers comprising silicone and acrylic moieties, and the like. Polymers comprising silicone and acrylic moieties may include copolymers comprising silicone and acrylic moieties, polymer blends comprising a silicone elastomer and an acrylic elastomer, for example.

Materials used as an electroactive polymer may be selected based on one or more material properties such as a high electrical breakdown strength, a low modulus of elasticity—(for large or small deformations), a high dielectric constant, and the like. In one embodiment, the polymer is selected such that is has an elastic modulus at most about 100 MPa. In another embodiment, the polymer is selected such that is has a maximum actuation pressure between about 0.05 MPa and about 10 MPa, and preferably between about 0.3 MPa and about 3 MPa. In another embodiment, the polymer is selected such that is has a dielectric constant between about 2 and about 20, and preferably between about 2.5 and about 12. The present disclosure is not intended to be limited to these ranges. Ideally, materials with a higher dielectric constant than the ranges given above would be desirable if the materials had both a high dielectric constant and a high dielectric strength. In many cases, electroactive polymers may be fabricated and implemented as thin films. Thicknesses suitable for these thin films may be below 50 micrometers.

As electroactive polymers may deflect at high strains, electrodes attached to the polymers should also deflect without compromising mechanical or electrical performance. Generally, electrodes suitable for use may be of any shape and material provided that they are able to supply a suitable voltage to, or receive a suitable voltage from, an electroactive polymer. The voltage may be either constant or varying over time. In one embodiment, the electrodes adhere to a surface of the polymer. Electrodes adhering to the polymer are preferably compliant and conform to the changing shape of the polymer. Correspondingly, the present disclosure may include compliant electrodes that conform to the shape of an electroactive polymer to which they are attached. The electrodes may be only applied to a portion of an electroactive polymer and define an active area according to their geometry. Various types of electrodes suitable for use with the present disclosure include structured electrodes comprising metal traces and charge distribution layers, textured electrodes comprising varying out of plane dimensions, conductive greases such as carbon greases or silver greases, colloidal suspensions, high aspect ratio conductive materials such as carbon fibrils and carbon nanotubes, and mixtures of ionically conductive materials.

Materials used for electrodes of the present disclosure may vary. Suitable materials used in an electrode may include graphite, carbon black, colloidal suspensions, thin metals including silver and gold, silver filled and carbon filled gels and polymers, and ionically or electronically conductive polymers. It is understood that certain electrode materials may work well with particular polymers and may not work as well for others. By way of example, carbon fibrils work well with acrylic elastomer polymers while not as well with silicone polymers.

The active material may also comprise a piezoelectric material. Also, in certain embodiments, the piezoelectric material may be configured as an actuator for providing rapid deployment. As used herein, the term “piezoelectric” is used to describe a material that mechanically deforms (changes shape) when a voltage potential is applied, or conversely, generates an electrical charge when mechanically deformed. Employing the piezoelectric material will utilize an electrical signal for activation. Upon activation, the piezoelectric material can cause displacement in the powered state. Upon discontinuation of the activation signal, the strips will assume its original shape orientation, e.g., a straightened shape orientation.

Preferably, a piezoelectric material is disposed on strips of a flexible metal or ceramic sheet. The strips can be unimorph or bimorph. Preferably, the strips are bimorph, because bimorphs generally exhibit more displacement than unimorphs.

One type of unimorph is a structure composed of a single piezoelectric element externally bonded to a flexible metal foil or strip, which is stimulated by the piezoelectric element when activated with a changing voltage and results in an axial buckling or deflection as it opposes the movement of the piezoelectric element. The actuator movement for a unimorph can be by contraction or expansion. Unimorphs can exhibit a strain of as high as about 10%, but generally can only sustain low loads relative to the overall dimensions of the unimorph structure.

In contrast to the unimorph piezoelectric device, a bimorph device includes an intermediate flexible metal foil sandwiched between two piezoelectric elements. Bimorphs exhibit more displacement than unimorphs because under the applied voltage one ceramic element will contract while the other expands. Bimorphs can exhibit strains up to about 20%, but similar to unimorphs, generally cannot sustain high loads relative to the overall dimensions of the unimorph structure.

Suitable piezoelectric materials include inorganic compounds, organic compounds, and metals. With regard to organic materials, all of the polymeric materials with non-centrosymmetric structure and large dipole moment group(s) on the main chain or on the side-chain, or on both chains within the molecules, can be used as candidates for the piezoelectric film. Examples of suitable polymers include, for example, but are not limited to, poly(sodium 4-styrenesulfonate) (“PSS”), poly S-119

(poly(vinylamine)backbone azo chromophore), and their derivatives; polyfluorocarbons, including polyvinylidene fluoride (“PVDF”), its co-polymer vinylidene fluoride (“VDF”), trifluoroethylene (TrFE), and their derivatives; polychlorocarbons, including poly(vinyl chloride) (“PVC”), polyvinylidene chloride (“PVDC”), and their derivatives; polyacrylonitriles (“PAN”), and their derivatives; polycarboxylic acids, including poly(methacrylic acid (“PMA”), and their derivatives; polyureas, and their derivatives; polyurethanes (“PU”), and their derivatives; bio-polymer molecules such as poly-L-lactic acids and their derivatives, and membrane proteins, as well as phosphate bio-molecules; polyanilines and their derivatives, and all of the derivatives of tetramines; polyimides, including Kapton molecules and polyetherimide (“PEI”), and their derivatives; all of the membrane polymers; poly(N-vinyl pyrrolidone) (“PVP”) homopolymer, and its derivatives, and random PVP-co-vinyl acetate (“PVAc”) copolymers; and all of the aromatic polymers with dipole moment groups in the main-chain or side-chains, or in both the main-chain and the side-chains, and mixtures thereof.

Further, piezoelectric materials can include Pt, Pd, Ni, Ti, Cr, Fe, Ag, Au, Cu, and metal alloys and mixtures thereof. These piezoelectric materials can also include, for example, metal oxide such as SiO2, Al2O3, ZrO2, TiO2, SrTiO3, PbTiO3, BaTiO3, FeO3, Fe3O4, ZnO, and mixtures thereof, and Group VIA and IIB compounds, such as CdSe, CdS, GaAs, AgCaSe 2, ZnSe, GaP, InP, ZnS, and mixtures thereof. Suitable active materials include, without limitation, shape memory alloys (SMA), ferromagnetic SMAs, shape memory polymers (SMP), piezoelectric materials, electroactive polymers (EAP), magnetorheological fluids and elastomers (MR), and electrorheological fluids (ER).

The activation signal provided by the activation device may include a heat signal, a magnetic signal, an electrical signal, a pneumatic signal, a mechanical signal, and the like, and combinations comprising at least one of the foregoing signals, with the particular activation signal dependent on the materials and/or configuration of the active material. For example, a magnetic and/or an electrical signal may be applied for changing the property of the active material fabricated from magnetostrictive materials. A heat signal may be applied for changing the property of the active material fabricated from shape memory alloys and/or shape memory polymers. An electrical signal may be applied for changing the property of the active material fabricated from electroactive materials, piezoelectrics, electrostatics, and/or ionic polymer metal composite materials.

In some embodiments, the active material 808 may be configured to change in size or shape and thereby exert a force that is transferred to the member 812, such as by a cam or the like. In other embodiments, the change in attribute of the active material may release a latch or open a valve, etc. to permit a spring or fluid pressure to transmit a force to the member 812. In one exemplary embodiment, actuator 804 is of the type described in U.S. patent application Ser. No. 11/533,417, filed Sep. 20, 2006, and which is hereby incorporated by reference in its entirety. In another exemplary embodiment, actuator 804 is of the type described in U.S. patent application Ser. No. 11/533,430, filed Sep. 20, 2006, and which is hereby incorporated by reference in its entirety. In yet another exemplary embodiment, actuator 804 is of the type described in U.S. patent application Ser. No. 11/533,422, filed Sep. 20, 2006, and which is hereby incorporated by reference in its entirety.

Within the scope of the claimed invention, the deployable member 812 may also be, for example, front and rear impact countermeasures, a laterally deploying beam stored within or adjacent to a rocker, a laterally deploying external side door beam (hidden, for example, within a rub strip or external molding), a laterally deploying assist step, a laterally deploying A, B, or C pillar or outboard or internal portions thereof, a means of outwardly expanding a door's outer surface including its side impact beam, structure being selectively movable downward to eliminate override, lower stroking force elements being selectively movable forward to “soften” the impact of a bumper on the side of the vehicle body, etc., within the scope of the claimed invention. Exemplary locations for actuator 804 include within a roof, seats, cross-car beams, floor pan, instrument panel, pillars, doors, and rockers.

While the best modes for carrying out the invention have been described in detail, those familiar with the art to which this invention relates will recognize various alternative designs and embodiments for practicing the invention within the scope of the appended claims.

1. A vehicle comprising:
a vehicle body;
at least one member being mounted with respect to the vehicle body and being selectively movable between first and second positions with respect to the vehicle body;
an actuator including an active material being configured to undergo a change in at least one attribute in response to an activation signal; said active material being operatively connected to said at least one member such that said change in at least one attribute causes said at least one member to move relative to the vehicle body; and
an impact detection system configured to detect at least one condition indicative of an impact event and configured to cause the actuator to move said at least one member from the first position to the second position in response to said at least one condition indicative of an impact event.

2. The vehicle of claim 1, wherein said at least one member includes a first L-shaped structure and a second L-shaped structure, wherein each of the L-shaped structures comprises a respective first portion and second portion, said second portions being generally perpendicularly oriented with respect to the first portions;
a cable fixedly attached to the second portions of the L-shaped structures;
wherein the second portions of the first and second L-shaped structures are generally horizontally oriented when the first and second L-shaped structures are in their respective first positions, and wherein the second portions are generally vertically oriented when the first and second L-shaped structures are in their respective second positions.

3. The vehicle of claim 2, wherein the second positions are outboard of the first positions.

4. The vehicle of claim 1, wherein said at least one member is a selectively expandable mechanical structure; wherein the mechanical structure occupies a first volume in the first position, and wherein the mechanical structure occupies a second volume greater than the first volume in the second position.

5. The vehicle of claim 4, wherein said selectively expandable mechanical structure comprises a honeycomb or otherwise celled material.

6. The vehicle of claim 1, wherein said at least one member includes a plurality of members that cooperate to at least partially define a cross car beam when in their respective second positions.

7. The vehicle of claim 1, wherein said at least one member is a seat assembly; and wherein said second position is inboard of said first position.

8. The vehicle of claim 1, wherein said at least one member includes at least one of a laterally deployable beam stored within or adjacent to a rocker, a laterally deployable door beam, a laterally deployable assist step, a laterally deployable pillar, a member mounted within a door being selectively deployable to outwardly expand the door's outer surface, structure being selectively movable downward to eliminate override, lower stroking force elements being selectively movable forward, and an outrigger that is selectively movable outward from the vehicle body.

9. The vehicle of claim 1, wherein the active material is selected from the group consisting of shape memory alloys, shape memory polymers, electroactive polymers, and piezoelectric materials.

10. The vehicle of claim 1, wherein said activation signal is selected from the group consisting of electric signals, magnetic signals, and thermal signals.

11. The vehicle of claim 1, wherein said impact detection system includes at least one sensor configured to detect the occurrence of an impact to the side of the vehicle body; and wherein said impact event is an impact to the side of the vehicle body.

12. The vehicle of claim 1, wherein said impact detection system includes at least one sensor configured to detect at least one condition indicative of an elevated possibility of an impact to the side of the vehicle body; and wherein said side impact event is the presence of said at least one condition indicative of an elevated possibility of an impact to the side of the vehicle body.

13. The vehicle of claim 1, wherein the impact detection system is configured to detect at least one condition indicative of a side impact event and configured to cause the actuator to move said at least one member from the first position to the second position in response to said at least one condition indicative of a side impact event.

14. A method comprising:
detecting at least one condition indicative of an impact event to a vehicle body; and
transmitting an activation signal to an active material in response to said detecting at least one condition indicative of an impact event to a vehicle body;
wherein said active material is configured to undergo a change in at least one attribute in response to an activation signal;
wherein said active material is operatively connected to at least one member such that said change in at least one attribute causes said at least one member to move from a first position to a second position with respect to the vehicle body.

15. The method of claim 14, wherein said impact event is a side impact event.

16. The method of claim 14, wherein said activation signal is selected from the group consisting of electric signals, magnetic signals, and thermal signals.

17. The method of claim 14, wherein the active material is selected from the group consisting of shape memory alloys, shape memory polymers, electroactive polymers, and piezoelectric materials.
